(19) United States
(12) Patent Application Publication
(10) Pub. No.: US 2026/0308837 A1
(43) Pub. Date: Oct. 8, 2026

(54) CLEANED, NON-SCOURED, COTTON AND METHODS OF PREPARING THE SAME

(71) Applicant: Barnhardt Manufacturing Co., Charlotte, NC (US)

(72) Inventors: Wade Monroe Hubbard, JR., Fort Mill, SC (US); Katherine Ann Tchinnis, Charlotte, NC (US); Eric Mariani, Richwiller (FR); Kyle Richardson Pearce, Kannapolis, NC (US)

(21) Appl. No.: 19/463,980

(22) Filed: Jan. 29, 2026

Related U.S. Application Data
(60) Provisional application No. 63/751,462, filed on Jan. 30, 2025.

(51) Int. Cl. D01G 9/00

(52) U.S. Cl. CPC D01G 9/00

(57) ABSTRACT

A process for cleaning cotton to remove metals, microorganisms, pesticides, and other contaminants is disclosed. The process includes washing the cotton with acid, rinsing with water, and neutralizing with base. The method may further include mechanically cleaning the cotton to remove plant material. The washed cotton prepared by this process is also disclosed, as well as any cotton products prepared from or comprising the washed cotton.

### TECHNICAL FIELD

The present invention relates to the field of cotton, and more specifically to the field of processing cotton fiber.

### BACKGROUND

In recent years, the demand for ingredient transparency and the overall reduction of ingredients used in processing products has increased dramatically. Consumers have a deep concern with product safety and the more ingredients there are, the higher the concern. This trend has extended beyond just the non-visible ingredients and has now made “off white, beige” products acceptable in many hygiene applications where previously only bright white materials were acceptable. Additionally, the demand for natural fiber options to replace synthetic fibers has risen at the same time. The complexity associated with using natural fibers is in cleaning and removing the extraneous material (stalk, stem, leaf, etc.) that comes along with the naturally grown fiber.

The traditional methods for creating cleaned cotton have been with a combination of mechanical cleaning, followed by a rigorous scouring, using sodium hydroxide, surfactants, and dispersants to remove dirt, metals, oils, waxes, etc., and finally bleaching, typically using hydrogen peroxide or sodium hypochlorite with synthesized chelation agents and stabilizers, to make the product white.

In the case of the fully whitened product, certain consumers feel that while they appreciate that microbes, residual metals, herbicides, pesticides and other substances of interest are removed, the amount of additional processing and ingredients used to do so is too great. The other option is to use a product which is only mechanically cleaned. However, this process/product does not remove residual metals, herbicides, pesticides and other undesired inorganic and organic materials. While various sterilization techniques, such as irradiation, autoclaving, etc., can be used for microorganisms for this product, again, consumers are wary of the long-term safety.

### SUMMARY

Accordingly, there is a need for a process that creates a cleaned cotton in which the cotton retains its natural state of color, ingredients and morphology, while still removing microorganisms, undesired inorganics, undesired organics, herbicides, pesticides and other undesired materials, without the addition of the various chemicals used in traditional scouring and bleaching.

In one aspect, a method of processing cotton fiber is disclosed. The method comprising: (a) washing cotton with an acidic solution to remove metals, microorganisms, herbicides, pesticides, or a combination thereof; (b) rinsing the cotton with water; (c) neutralizing the cotton with a basic solution; and (d) drying the cotton to produce a cleaned, non-scoured cotton. prior to step (a) the cotton is mechanically cleaned to removed extraneous plant components.

In certain aspects, the acidic solution comprises a carboxylic acid, dicarboxylic acids, inorganic acids, alpha-hydroxy acids, or a combination thereof. Examples of acids selected from these groups consist of citric acid, sulfuric acid, acetic acid, malic acid, maleic acid, fumaric acid, lactic acid, oxalic acid, or a combination thereof. In certain aspects, the acid wash comprises from 1% to 6% owf carboxylic acid and 0.01% to 0.30% owf inorganic acid. In certain aspects, the basic solution comprises sodium carbonate.

In certain aspects, the cleaned, non-scoured cotton has an L-value of less than 90, preferably between 75 and 90. In certain aspects, the cleaned, non-scoured cotton has a b-value greater than 4, preferably between 4.5 and 15. In certain aspects, the cleaned, non-scoured cotton comprises ether extractable components less than 0.70%, preferably between 0.01% and 0.70%. In certain aspects, the cleaned, non-scoured cotton has water extractable components less than 0.35%, preferably between 0.01% and 0.35%. In certain aspects, the cleaned, non-scoured cotton has residue on ignition less than 0.2%, preferably between 0.01% and 0.2%. In certain aspects, the cleaned, non-scoured cotton has an undetectable level of glyphosate, AMPA, and pesticides at a non-detect level with a 10 ppb LOQ. In certain aspects, the cleaned, non-scoured cotton has a residual microbiological level less than 100 CFU/g, preferably between 0 to 100 CFU/.

In another aspect, a cleaned cotton processed by the method described above is disclosed.

In another aspect, a cotton product comprising cotton processed by the method of described above is disclosed. In certain aspects, the cotton product may further comprise additional fibers selected from the group consisting of: polyester, polypropylene, polylactic acid, polyhydroxyalkanoate, bicomponent fibers, regenerated cellulose, natural cellulose, or a combination thereof.

Additional features, aspects and advantages of the invention will be set forth in the detailed description which follows, and in part will be readily apparent to those skilled in the art from that description or recognized by practicing the invention as described herein. It is to be understood that both the foregoing general description and the following detailed description present various embodiments of the invention, and are intended to provide an overview or framework for understanding the nature and character of the invention as it is claimed. The accompanying drawings are included to provide a further understanding of the invention, and are incorporated in and constitute a part of this specification.

### BRIEF DESCRIPTION OF THE DRAWINGS

The drawings described herein are for illustrative purposes for selected embodiments and not all possible implementations and are not intended to limit the scope of the present disclosure.

FIG. 1 illustrates a method according to embodiments described herein.

FIG. 2 quantitatively shows ether extractable components of cotton processed according to embodiments described herein compared with prior art methods.

FIG. 3 quantitatively shows the water extractable components of cotton processed according to embodiments described herein compared with prior art methods.

FIG. 4 quantitatively shows residue on ignition components of cotton processed according to embodiments described herein compared with prior art methods.

FIG. 5 quantitatively shows the L-value of cotton processed according to embodiments described herein compared with prior art methods.

FIG. 6 quantitatively shows the b value of cotton processed according to embodiments described herein compared with prior art methods.

FIG. 7 quantitatively shows the residue on ignition extractable components of cotton processed according to embodiments described herein compared with prior art methods.

FIG. 8 quantitatively shows the water components of cotton processed according to embodiments described herein compared with prior art methods.

FIG. 9 quantitatively shows the pesticide, AMPA, and glyphosate components of cotton processed according to embodiments described herein compared with prior art methods.

### DETAILED DESCRIPTION OF EMBODIMENTS OF THE INVENTION

The present invention will now be described more fully hereinafter with reference to the working examples in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention.

Further, the term “or” as used in this disclosure and the appended claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in,” “at,” and/or “on,” unless the context clearly indicates otherwise. The phrase “in one embodiment,” as used herein does not necessarily refer to the same embodiment, although it may.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within the ranges as if each numerical value and sub-range is explicitly recited. As an illustration, a numerical range of “about 1 to 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc. as well as 1, 2, 3, 4, and 5, individually. The same principle applies to ranges reciting only one numerical value as a minimum or a maximum. Furthermore, such an interpretation should apply regardless of the breadth of the range, or the characteristics being described.

“Owf” or percent on weight of fiber is generally used in the field and batch processes, the amount of chemical finish to be applied is usually expressed as a weight percentage based on the original fiber weight. This relationship is abbreviated as % owf (percent on weight of fiber), which is % owf=[(Weight of Chemical/Weight of fiber)*100]/Wet pickup rate %. For example, if a chemical is to be applied at 3% owf to 400 kg of fiber, having a wet pickup rate=80%, then 15 kg of the chemical will be used (3% of 400 kg at 80% pickup). Fiber may be in staple, carded, yarn, or non-woven form.

### Method of Cleaning Cotton

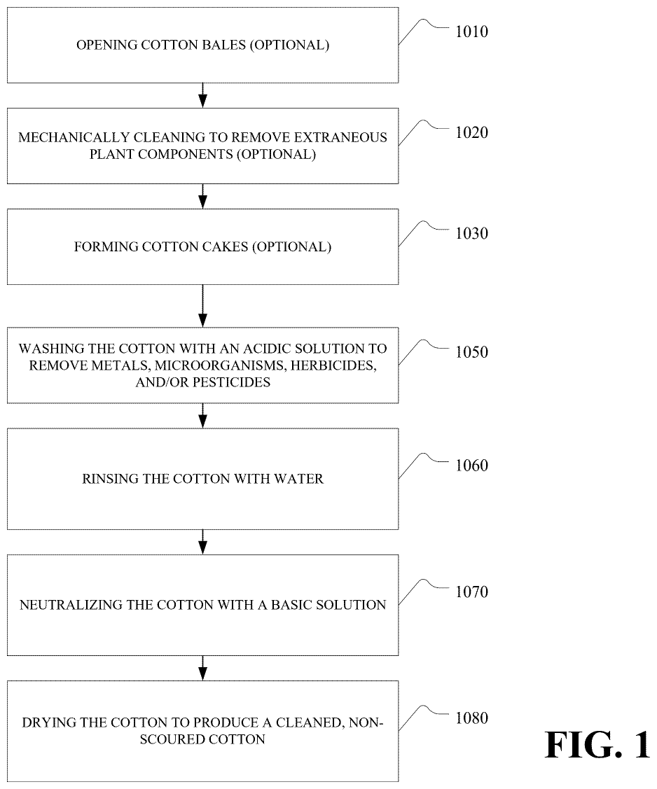

The method of cleaning cotton described herein is less harsh than the traditional bleaching and scouring process. Cotton processed by the method described herein maintains a natural color but is substantially free of metals, herbicides, pesticides, and other impurities. In some embodiments the cotton is mechanically cleaned and/or packaged into cakes prior to the process described herein. The process is illustrated in FIG. 1.

The method may include, opening cotton bales (1010), mechanically cleaning the cotton to remove, or break up into non-detectable sizes, plant matter such as stalk, stem, and leaves, as well as other extraneous material (1020). After this step, the cotton may be wetted out and packed into large cakes for further processing (1030). At this stage, the large cakes, or other cotton, are washed with an acidic solution to remove metals, microorganisms, herbicides, and/or pesticides (1050). The acidic solution may comprise a carboxylic acid, dicarboxylic acids, inorganic acids, alpha-hydroxy acids, or a combination thereof. Examples of acids selected from these groups consist of citric acid, sulfuric acid, acetic acid, malic acid, maleic acid, fumaric acid, lactic acid, oxalic acid, or a combination thereof. The acidic solution may be any combination of citric acid, sulfuric acid, acetic acid, malic acid, maleic acid, fumaric acid, succinic acid, tartaric acid, lactic acid, and oxalic acid. The acid wash may comprise from 2.0% to 3.0% owf citric acid and 0.05% to 0.30% owf sulfuric acid. The acid wash serves to clean the cotton of metals, microorganisms, herbicides, and/or pesticides. The acid wash may comprise a first acid wash and a second acid wash. The acid wash may further comprise heating the cotton to a temperature from 180° F. to 250° F., more preferably from 195° F. to 210° F. The acid wash may take anywhere from 15 minutes to 90 minutes, more preferably 45 minutes to 70 minutes. The wash time will be dependent on the size and physical shape or form of the cotton being processed.

Following the acid wash, the cotton is rinsed with water (1060). The cotton may be rinsed once, or multiple times to remove the metals, microorganisms, herbicides, and/or pesticides. The rinse step may occur at elevated temperatures from 120° F. to 200° F., more preferably from 140° F. to 165° F. The rinse time will be dependent on the size and physical shape or form of the cotton being processed. Following the rinse step, the cotton may be neutralized with a basic solution (1070). The basic solution may comprise any known base such as sodium carbonate, sodium hydroxide, potassium hydroxide, or potassium carbonate. The basic solution may comprise from 0.01% owf to 0.5% owf. In some embodiments a lubricant may be added to the cotton to reduce fiber friction during processing. Following cleaning, the cotton may be dried (1080) and processed into bales.

This method can also be used to clean other natural fibers, including but not limited to: hemp, jute, flax, kapok, banana, and bamboo.

### Clean, Non-Scoured Cotton

Cotton prepared by the process described above “washed” was analyzed and compared with cotton prepared by conventional methods, scouring and bleaching “bleached”, as well as to cotton that was only cleaned mechanically “mech. cleaned,” as well as with raw cotton “raw.”

The cotton used in the analysis below was washed with 2.5% owf citric acid and 0.2% owf sulfuric acid in water at 200° F. for 60 minutes. After the acid wash, the cotton was rinsed twice at 150° F. for 10 minutes each rinse, followed by a neutralization with 0.05% owf sodium carbonate in water. The cotton was then unloaded, separated, and dried before packaging into bales. Approximately 2700 lb of cotton was processed in five 540 lb cakes.

The ether extractable components, water extractable components, and residue on ignition components are measured using USP Testing Monograph 670 Auxiliary Packaging Component—Purified Cotton—U.S. Pharmacopeia Convention—1 Dec. 2023.

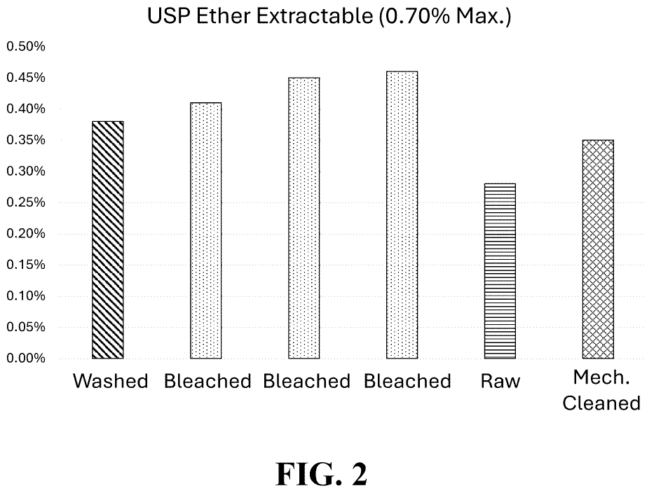

As shown in FIG. 2, the washed cotton shows less ether extractable components than bleached cotton, but more than raw and mechanically cleaned cotton.

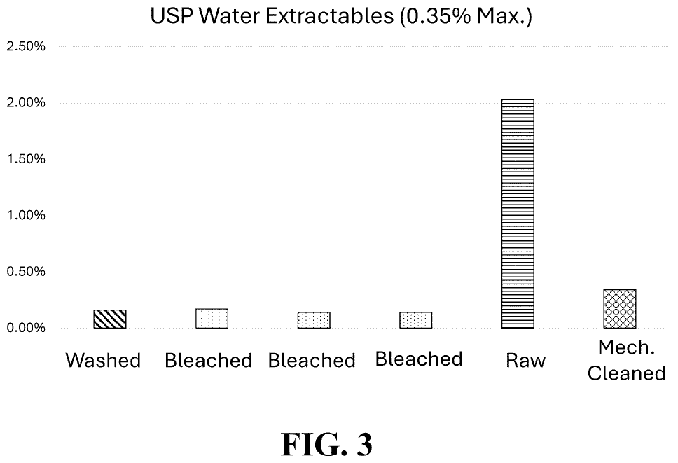

As shown in FIG. 3, the washed cotton shows comparable water extractable components to bleached cotton, but significantly less than raw cotton and less than mechanically cleaned cotton.

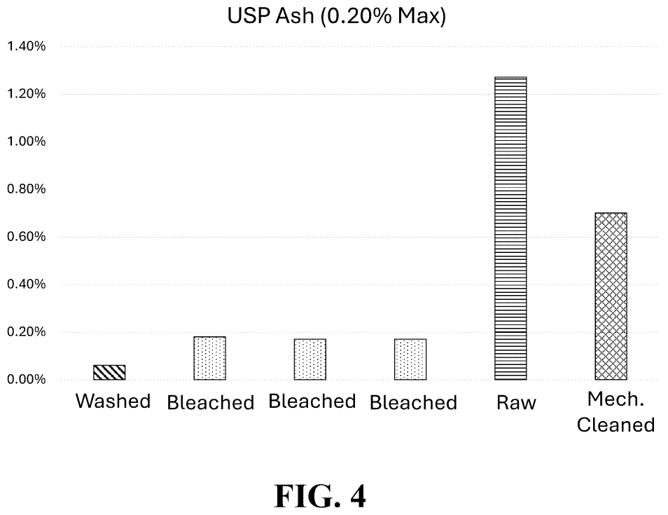

As shown in FIG. 4, the washed cotton shows less residue on ignition components than bleached cotton, and significantly less than raw cotton and mechanically cleaned cotton.

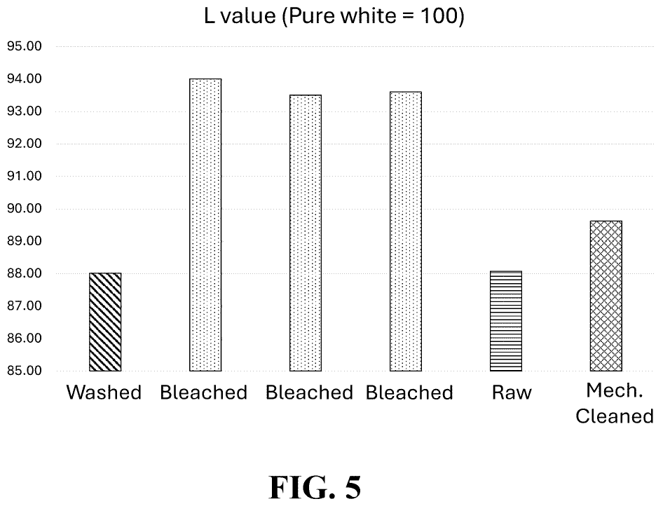

As shown in FIG. 5, the washed cotton shows an L value comparable to raw cotton, and significantly less than bleached cotton. The L-value is a measure of how white the cotton is. This is determined by using a colorimeter using a setting of 10 for angle and D65 for illumination, using the L*a*b* method. The washed cotton has an L-value similar to raw cotton. Bleached cotton has a higher L-value, as expected. The mechanically cleaned cotton has an L-value higher than raw.

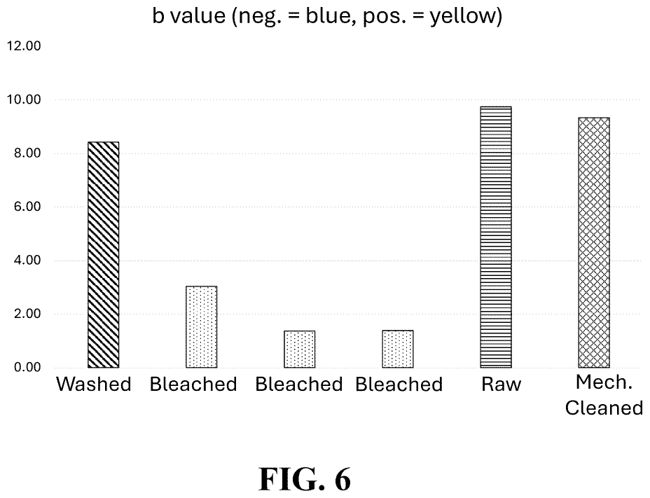

As shown in FIG. 6, the washed cotton shows a b value higher than bleached cotton, but less than raw cotton and mechanically cleaned cotton. The b-value is a measure of how yellow (positive number) or blue (negative number) the cotton is. This also is measured using a colorimeter. The washed cotton has a more positive b-value than bleached cotton, but a less positive b-value than raw or mechanically cleaned cotton.

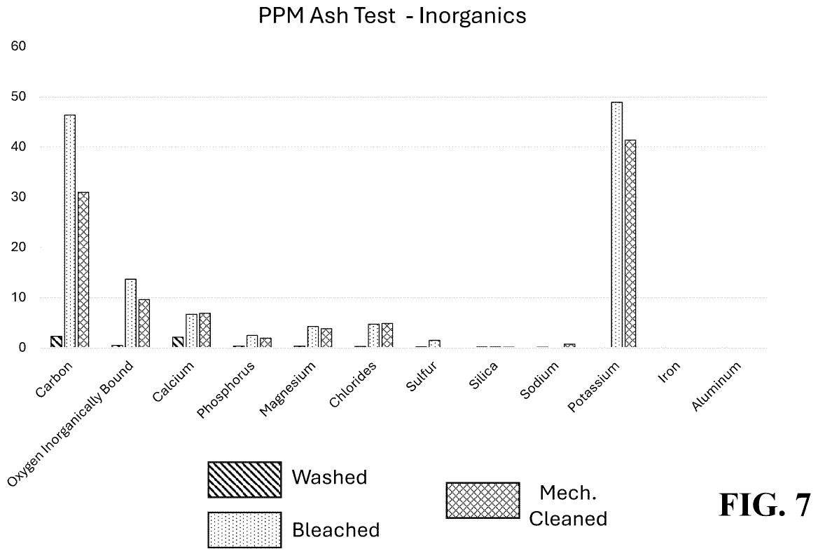

As shown in FIG. 7, according to an ash test measuring inorganics, the washed cotton shows significantly less carbon, inorganic bound oxygen, calcium, phosphorous, magnesium, chlorides, sodium, and potassium when compared to mechanically cleaned cotton. The washed cotton shows less, and in some cases substantially less, carbon, inorganic bound oxygen, calcium, phosphorous, magnesium, chlorides, sodium, and potassium when compared to bleached cotton.

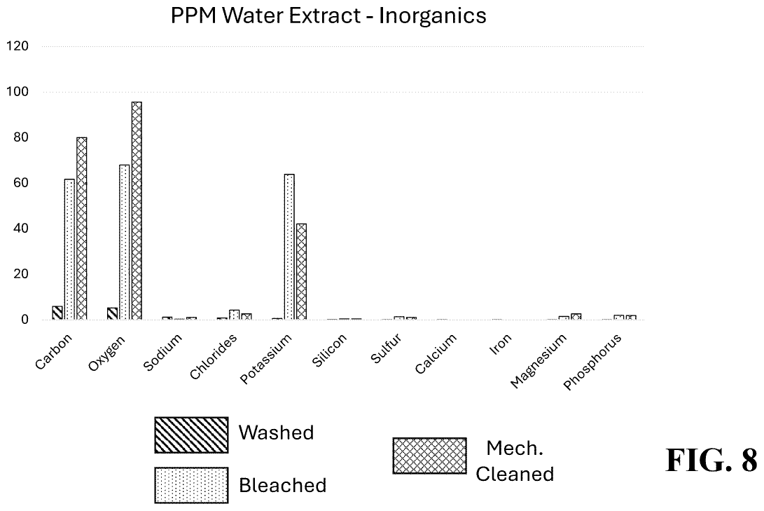

As shown in FIG. 8, the washed cotton shows significantly less carbon, oxygen, sodium, and potassium in the water extract than mechanically cleaned cotton. The washed cotton shows significantly less carbon, oxygen, sodium, and potassium in the water extract than bleached cotton.

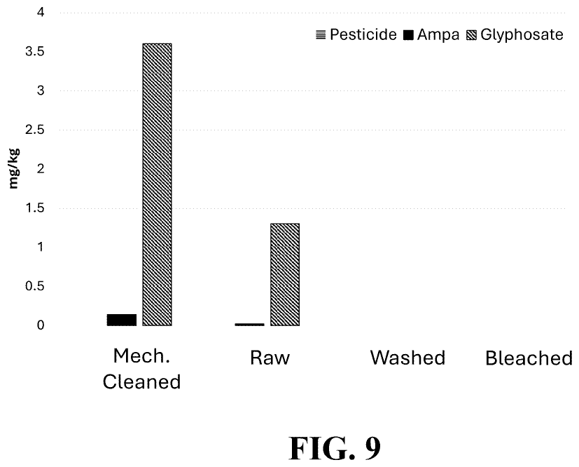

The AMPA (α-amino-3-hydroxy-5-methyl-4-isoxazole propionic acid), pesticide, and glyphosate content in the four types of cotton were evaluated by LCMS via method European Standard Test Method: EN 15662:2018-07 Modular QuEChERS-method (for pesticides) and USEPA SOP-0232; 2011-06 (for AMPA and glyphosate). As shown in FIG. 9, the washed cotton shows no detectable amounts of pesticide, AMPA, and glyphosate. The bleached cotton also shows no detectable amounts pesticide, AMPA, and glyphosate. The mechanically cleaned cotton and the raw cotton show a substantial amount of pesticide and detectable amounts of AMPA.

It is also contemplated that other natural fibers, hemp, jute, flax, kapok, banana, and bamboo cleaned, or processed, as described herein would have similar properties.

### Cotton Products

The cleaned, non-scoured cotton described above may be used to make various cotton products, including but not limited to feminine hygiene products; wound dressings; clothing; beauty products such as wipes, balls, swabs, and pads; hard-surface wipes; baby wipes; diapers; quilting; non-wovens; etc.

The cotton may be used alone to form cotton products. Alternatively, the cotton may be combined with other fibers to form cotton products with desired hydrophobicity or hydrophilicity. Examples of other fibers include, but are not limited to polyester, polypropylene, polylactic acid, polyhydroxyalkanoates, bicomponent fibers, regenerated cellulose (viscose, lyocell, etc.), and/or natural cellulose (hemp, flax, jute, cotton, kapok, etc).

It is also contemplated that other natural fibers cleaned, or processed, as described herein, such as hemp, jute, flax, kapok, banana, and bamboo may be incorporated into products as described herein.

The foregoing description provides embodiments of the invention by way of example only. It is envisioned that other embodiments may perform similar functions and/or achieve similar results. Any and all such equivalent embodiments and examples are within the scope of the present invention and are intended to be covered by the appended claims.

What is claimed is:

1. A method of processing cotton fiber, the method comprising:
a. washing cotton with an acidic solution to remove metals, microorganisms, herbicides, pesticides, or a combination thereof;
b. rinsing the cotton with water;
c. neutralizing the cotton with a basic solution; and
d. drying the cotton to produce a cleaned, non-scoured cotton.

2. The method according to claim 1, wherein the acidic solution is limited to 1 to 3 components.

3. The method according to claim 1, wherein prior to step (a) the method further comprises mechanically cleaning the cotton to removed extraneous plant components.

4. The method according to claim 1, wherein the acidic solution comprises a carboxylic acid, dicarboxylic acids, inorganic acids, alpha-hydroxy acids, or a combination thereof.

5. The method according to claim 1, wherein the acidic solution comprises an acid selected from the group consisting of citric acid, sulfuric acid, acetic acid, malic acid, maleic acid, fumaric acid, succinic acid, tartaric acid, lactic acid, oxalic acid, or a combination thereof.

6. The method according to claim 1, wherein the basic solution comprises sodium carbonate.

7. The method according to claim 1, wherein the cleaned, non-scoured cotton has an L-value between 75 and 90.

8. The method according to claim 1, wherein the cleaned, non-scoured cotton has a b-value between 4.5 and 15.

9. The method according to claim 1, wherein the cleaned, non-scoured cotton has ether extractable components between 0.01% and 0.70%.

10. The method according to claim 1, wherein the cleaned, non-scoured cotton has water extractable components between 0.01% and 0.35%.

11. The method according to claim 1, wherein the cleaned, non-scoured cotton has residue on ignition between 0.01% and 0.2%.

12. The method according claim 1, wherein the cleaned, non-scoured cotton has glyphosate, AMPA, and pesticide at a non-detect level with a 10 ppb LOQ.

13. The method according to claim 1, wherein the cleaned, non-scoured cotton has a residual microbiological between 0 to 100 CFU/g.

14. The method according to claim 1, wherein the cleaned, non-scoured cotton comprises no detectable amounts of glyphosate, AMPA, and/or pesticides.

15. The method according to claim 5, wherein the acid wash comprises from 2.0% to 3.0% owf citric acid and 0.05% to 0.30% owf sulfuric acid.

16. A cleaned cotton processed by the method of claim 1.

17. The cleaned cotton according to claim 16, wherein the cleaned cotton has an L-value between 75 and 90.

18. The cleaned cotton according to claim 16, wherein the cleaned cotton has a b-value between 4.5 and 15.

19. The cleaned cotton according to claim 16, wherein the cleaned cotton has ether extractable components between 0.01% and 0.70%.

20. The cleaned cotton according to claim 16, wherein the cleaned cotton has water extractable components between 0.01% and 0.35%.

21. The cleaned cotton according claim 16, wherein the cleaned cotton has a residue on ignition between 0.01% and 0.2%.

22. The cleaned cotton according to claim 16, wherein the cleaned cotton comprises no detectable amounts of glyphosate, AMPA, and/or pesticides.

23. A cotton product comprising cotton processed by the method of claim 1.

24. The cotton product according to claim 23, further comprising additional fibers selected from the group consisting of: polyester, polypropylene, polylactic acid, polyhydroxyalkanoate, bicomponent fibers, regenerated cellulose, natural cellulose, and a combination thereof.
